(19) United States
(12) Patent Application Publication
(10) Pub. No.: US 2024/0059014 A1
(43) Pub. Date: Feb. 22, 2024

(54) 3D PRINTING DEVICE AND METHOD

(71) Applicant: BMF NANO MATERIAL TECHNOLOGY CO., LTD, Shenzhen (CN)

(72) Inventor: Chong PENG, Shenzhen (CN)

(73) Assignee: BMF NANO MATERIAL TECHNOLOGY CO., LTD, Shenzhen, GD (CN)

(21) Appl. No.: 18/498,070

(22) Filed: Oct. 31, 2023

Related U.S. Application Data
(63) Continuation of application No. PCT/CN2022/101742, filed on Jun. 28, 2022.

(30) Foreign Application Priority Data
Jun. 20, 2022 (CN) 202210698145.8

(51) Int. Cl. B29C 64/245; B29C 64/129; B29C 64/214; B29C 64/232; B29C 64/236; B29C 64/393; B33Y 30/00; B33Y 50/02

(52) U.S. Cl. CPC B29C 64/245; B29C 64/129; B29C 64/214; B29C 64/232; B29C 64/236; B29C 64/393; B33Y 30/00; B33Y 50/02

(57) ABSTRACT

A 3D printing device includes a liquid bath, a printing platform, a release film assembly, a levelling hob assembly, and a bubble scraper. One side of the liquid bath is widened to form an extending area. The bubble scraper is disposed in the extending area, fixed at the bottom of the extending area, and located at a side close to a main area. The release film assembly and the levelling hob assembly are capable of moving horizontally. The invention has the following beneficial effects: 1. manual operations before and after printing are reduced and simplified; 2. the risk of damage to a levelling hob caused by frequent manual assembly and disassembly is lowered, and the waste of time caused by repeated levelling of the hob due to reassembly of the levelling hob is reduced; 3. the risk of contamination caused by dripping of the liquid resin is lowered.

### FIELD

The application belongs to the technical field of photocuring 3D printing, and particularly relates to a 3D printing device and method easy to operate.

### BACKGROUND

At present, during high-accuracy photocuring 3D printing, a photocuring 3D printer is usually disposed above a liquid bath, such that a thinner release film can be used, or even self-levelling can be used to allow a pattern to be projected onto photosensitive resin accurately, to obtain higher accuracy. However, with the rise of the requirements for the printing breadth and the viscosity of suitable liquid resin, there is still a long levelling wait time before a desired coating thickness is obtained in the actual printing process even if a release film is used. A new quick levelling method based on a hob is developed by BMF to solve the problem of low efficiency caused by a long levelling time during printing. As shown in FIG. 1 which is a schematic diagram of an existing 3D printer, a light path is located above a liquid bath 1, and a release film assembly 3 is fixed in the liquid bath 1. When a printing platform 2 ascends, liquid resin 6 carried by the printing platform 2 makes the release film assembly 3 bulge upwards. At this moment, a levelling hob 4 disposed on an upper surface of the release film assembly 3 is capable of rolling leftwards and rightwards to level the release film assembly 3, such that the levelling wait time during printing can be greatly shortened. The printer also adopts a bubble scraper 5 which can slide leftwards and rightwards along a lower surface of the release film assembly 3 to eliminate bubbles on the lower surface of the release film assembly 3, preventing the printing quality being affected by bubbles. By adopting the existing printer, before printing, the printing platform 2, the release film assembly 3 and the levelling hob 4 need to be manually assembled sequentially; and after printing, the levelling hob 4, the release film assembly 3 and the printing platform 2 need to be manually disassembled sequentially to obtain a printed sample.

By adopting the traditional quick levelling method based on the hob, before printing, the printing platform 2, the release film assembly 3 and the levelling hob 4 need to be manually assembled sequentially; and after printing, the levelling hob 4, the release film assembly 3 and the printing platform 2 need to be manually disassembled sequentially to obtain a printed sample.

The existing printing method has the following defects:
1. Manual operations before and after printing are frequent and complex;
2. The levelling hob, as a fragile precision part, may be damaged due to frequent manual assembly and disassembly;
3. When the release film is taken down, liquid resin adhered to the release film may drip and case contamination.

### SUMMARY

The technical issue to be settled by the invention is to provide a 3D printing device and method easy to operate to solve the problems that, in the prior art, a levelling hob, a release film assembly and a printing platform need to be manually disassembled sequentially to obtain a printed sample.

In one aspect, the present application provides a 3D printing device which comprises:

a liquid bath configured to contain liquid resin used for printing, the liquid bath comprising a main area and an extending area disposed on a side of a top of the main area;

a printing platform configured to carry a printed sample and inserted into the main area of the liquid bath;

a release film assembly comprising a release film and a release film driving unit used for driving the release film to move horizontally between the main area and the extending area;

a levelling hob assembly comprising a levelling hob, and a hob driving unit configured for driving the levelling hob to move horizontally between the main area and the extending area, a bottom of the levelling main part being flush with an upper surface of the release film; and

a bubble scraper disposed in the extending area, fixed on a bottom of the extending area of the liquid bath, and located at a side, close to the main area, of the extending area, a top of the bubble scraper being flush with a bottom of the release film.

Preferably, the bubble scraper is mounted on the bottom of the extending area of the liquid bath through a spring and a guide shaft.

Preferably, the release film assembly comprises a mounting base plate; linear rails fixed on the mounting base plate and extending in a first direction, wherein the first direction is a moving direction of the printing platform between the main area and the extending area of the liquid bath; and a release film support unit mounted on the linear rails, driven by the release film driving unit to move in the first direction, the release film support unit comprising a release film tensioning fixture, wherein the release film is mounted on the release film tensioning fixture.

Preferably, the release film support unit comprises a transmission frame connected to the linear rails through first sliders; release film levelling pillars fixed on the transmission frame; and a levelling frame connected with the release film levelling pillars through release film levelling knobs, wherein the release film tensioning fixture is mounted on the levelling frame.

Preferably, the release film driving unit comprises a first stepping motor fixed at a bottom of the mounting base plate; and a first synchronous belt connected with the first stepping motor and the transmission frame to drive the transmission frame.

Preferably, stop blocks are disposed on the mounting base plate and located at four corners of the mounting base plate to prevent the transmission frame from moving out of limit.

Preferably, a position sensor is disposed on the mounting base plate, located on an edge of a side of the mounting base plate, and used for sensing a position of the transmission frame, and a horizontal moving position of the release film tensioning fixture is limited by the position sensor.

Preferably, the hob driving unit comprises a second stepping motor fixed at the bottom of the mounting base plate; and a second synchronous belt connected with the second stepping motor and a hob support unit to drive the hob support unit, wherein the hob support unit is movably mounted on the linear rails.

Preferably, the hob support unit comprises a transmission link connected with the linear rails through second sliders; and a rear hob levelling pillar and a front hob levelling pillar which are mounted on two sides of the transmission link respectively, wherein a joint of the rear hob levelling pillar and the transmission link and a joint of the front hob levelling pillar and the transmission link are adjustable through a rear hob levelling knob and a front hob levelling knob respectively. A top of the rear hob levelling pillar and a top of the front hob levelling pillar are connected with the levelling hob.

In another aspect, the present application provides a 3D printing method using a release film to push liquid horizontally to realize coating, wherein the 3D printing device described above is used and the 3D printing method comprises:
S1, moving the release film and the levelling hob assembly to the extending area, and installing the printing platform in the main area of the liquid bath;
S2, controlling the release film to move to the main area, controlling the printing platform to move to a printing position to ensure that the printing platform is spaced from a lower surface of the release film by a coating thickness, and waiting for levelling;
S3, keeping the release film static, and moving the levelling hob assembly towards the main area of the liquid bath unit it reaches an edge of one side of the release film;
S4, keeping the release film static, and moving the levelling hob assembly to an edge of an opposite side of the release film;
S5, repeating S3-S4 until a bulge of the release film is eliminated;
S6, focusing a pattern on the release film through a UV lens, and performing exposure and curing to obtain a cured pattern;
S7, controlling the printing platform to descend to separate the printed sample obtained after curing from the release film;
S8, controlling the release film and the levelling hob assembly to horizontally move to the extending area of the liquid bath, and then controlling the bubble scraper to ascend to firmly contact the lower surface of the release film;
S9, controlling the release film and the levelling hob assembly to horizontally move to the main area of the liquid bath, removing bubbles accumulated at the lower surface of the release film by means of the bubble scraper, and then controlling the bubble scraper to descend;
S10, repeating S2-S9 until the sample is completely printed; and
S11, controlling the release film and the levelling hob assembly to horizontally move to the extending area of the liquid bath, and disassembling the printing platform with the printed sample from the liquid bath.

The invention has the following beneficial effects:
1. Manual operations before and after printing are reduced and simplified;
2. The risk of damage to the levelling hob, which is a fragile precision part, caused by frequent manual assembly and disassembly is lowered, and the waste of time caused by repeatedly levelling of the hob when the levelling hob is reassembled is reduced;
3. Because liquid resin will not be adhered to the release film when the release film is taken down, the risk of contamination caused by dripping of the liquid resin is lowered.

### BRIEF DESCRIPTION OF THE DRAWINGS

The technical solution of the application will be further described below in conjunction with accompanying drawings and embodiments.

FIG. 1 is a principle diagram of traditional 3D printing using a hob for levelling;

FIG. 2 is a structural diagram of a 3D printing device easy to operate according to one embodiment of the application;

FIG. 3 is a schematic diagram of operating steps of the 3D printing device easy to operate according to one embodiment of the application;

FIG. 4 is an overall three-dimensional structural view of the 3D printing device easy to operate according to one embodiment of the application;

FIG. 5 is an overall structural side view of the 3D printing device easy to operate according to one embodiment of the application;

FIG. 6 is a structural diagram of a release film assembly and a levelling hob assembly according to one embodiment of the application;

FIG. 7 is a structural view of a liquid bath component according to one embodiment of the application;

FIG. 8 is a structural diagram of a levelling hob and a bubble scraper main part according to one embodiment of the application;

FIG. 9 illustrates the release film assembly in another aspect; and

FIG. 10 is an enlarged view of an encircled portion A of FIG. 9.

### REFERENCE SIGNS IN THE FIGURES

1, liquid bath; 2, printing platform; 3, release film assembly; 4, levelling hob assembly; 5, bubble scraper; 6, liquid resin; 7, printed sample; 8, UV lens; 122 and 124, first slider; 123, second slider; 101, mounting base plate; 102 and 103, linear rail; 104, second stepping motor; 105, first stepping motor; 106, second synchronous belt; 107, first synchronous belt; 108, stop block; 109, transmission frame; 110, 111 and 112, release film levelling pillar; 113, levelling frame; 114, position sensor; 115, transmission link; 116, rear hob levelling pillar; 117, front hob levelling pillar; 118, rear hob levelling knob; 119, front hob levelling knob; 120 and 121, release film levelling knob; 500, release film tensioning fixture; 200, liquid bath main part; 400, bubble scraper main part, 52, spring; 51, guide shaft.

### DESCRIPTION OF THE EMBODIMENTS

It should be pointed out that the embodiments of the application and the features in the embodiments can be combined without conflicts.

In the description of the application, it should be understood that terms such as “centre”, “lengthwise”, “crosswise”, “upper”, “lower”, “front”, “back”, “left”, “right”, “vertical”, “horizontal”, “top”, “bottom”, “inner” and “outer”, are used to indicate directional or positional relationships based on the accompanying drawings merely for the purpose of facilitating and simplifying the description of the application, do not indicate or imply that devices or elements referred to must be in a direction, or be constructed and operated in a specific direction, and thus, should not be construed as limiting the protection scope of the invention. In addition, terms such as “first” and “second” are merely for a purpose of description, and should not be construed as indicating or implying relative importance or implicitly indicating the number of technical features referred to. So, a feature defined by “first” or “second” may explicitly or implicitly indicate the inclusion of one or more said features. In the description of the invention, unless otherwise stated, “multiple” refers to two or more.

It should be noted that unless otherwise expressly stated and defined, terms such as “mount”, “connect” and “link” in the description of the invention should be broadly understood. For example, “connect” may refer to fixed connection, detachable connection or integrated connection, or mechanical connection or electrical connection, or direct connection, indirect connection through an intermediate medium, or internal connection of two elements. Those skilled in the art can appreciate the specific meanings of these terms in the application as the case maybe.

The technical solution of the application will be described in detail below with reference to the accompanying drawings and embodiments.

### EMBODIMENT

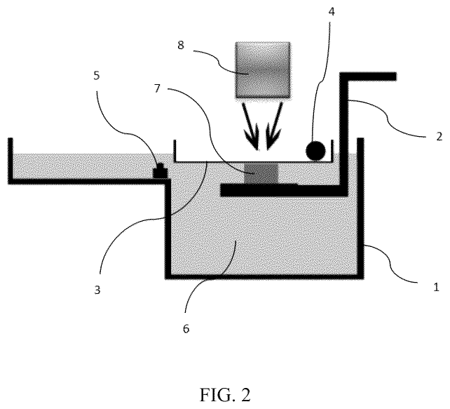

This embodiment provides a 3D printing device easy to operate. As shown in FIG. 2, the 3D printing device comprises:

A liquid bath 1 configured to contain liquid resin 6 which is used for printing and has a main area and an extending area, the extending area being disposed on one side of the top of the main area;

A printing platform 2 configured to carry a printed sample 7 and inserted into the main area of the liquid bath 1;

A release film assembly 3 comprising a release film and a release film driving unit used for driving the release film to move horizontally between the main area and the extending area;

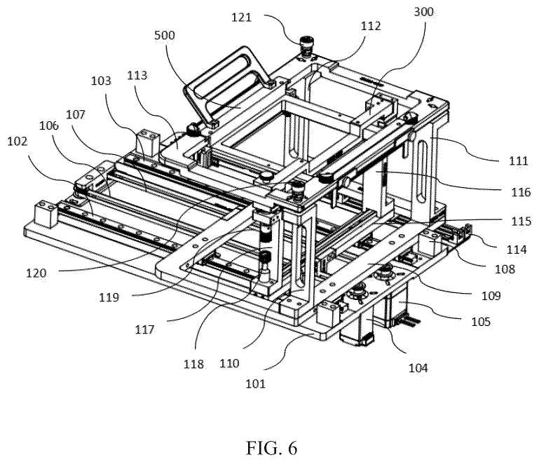

A levelling hob assembly 4 comprising a levelling hob 300 (shown in FIG. 6), and a hob driving unit used for driving the levelling hob 300 to move horizontally between the main area and the extending area, the bottom of the levelling hob 300 being flush with an upper surface of the release film; and

A bubble scraper 5 disposed in the extending area, fixed at the bottom of the extending area of the liquid bath 1, and located on a side close to the main area, the top of the bubble scraper 5 being flush with the bottom of the release film.

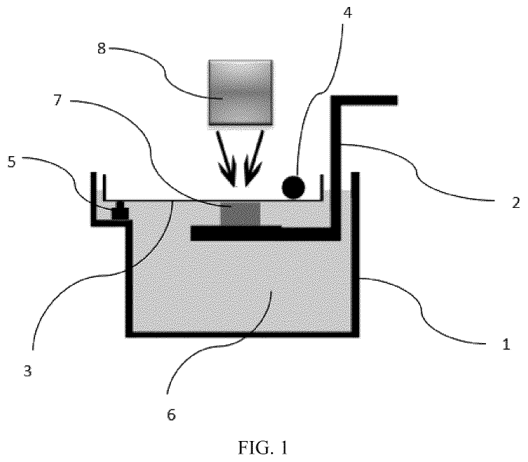

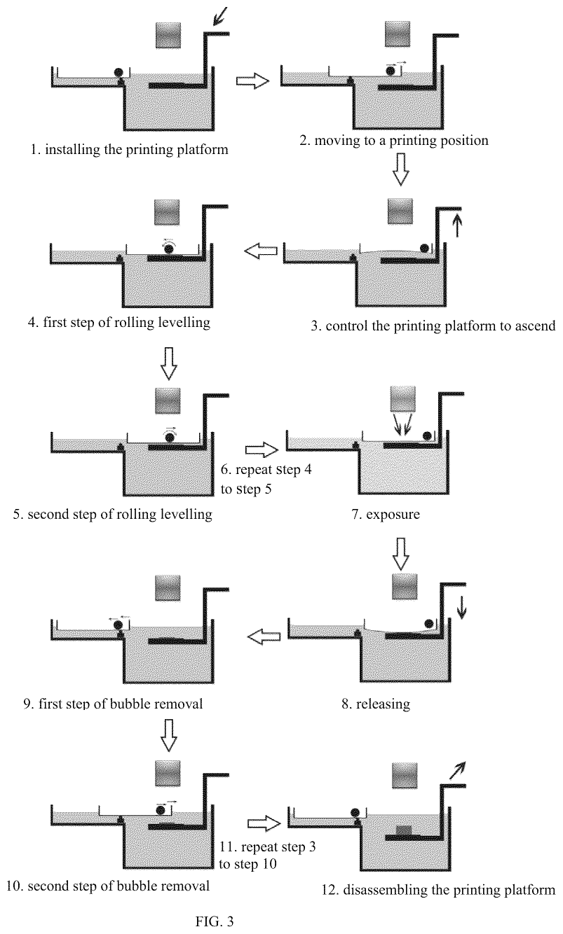

According to the 3D printing device in this embodiment, the printing platform 2 is driven by a moving shaft (not shown) to ascend or descend, ascending and descending of the printing platform 2, movements of the release film assembly 3, UV exposure, and other motions are controlled by control software installed in an industrial personal computer, and the control software controls all components to act according to the flow diagram in FIG. 3. Innovations are made to the liquid bath 1, the release film assembly 3, the levelling hob 4, the bubble scraper 5 and specific printing process in the prior art (shown in FIG. 1) in the following aspects: the width of the left side of the liquid bath 1 is increased, the release film assembly 3 is allowed to move leftwards and rightwards, and the installation structure of the bubble scraper 5 is improved, such that the printed sample can be taken out without disassembling the release film assembly and the levelling hob assembly, and the printing platform 2 can be easily assembled or disassembled only by horizontally moving the release film to the left side of the liquid bath after printing.

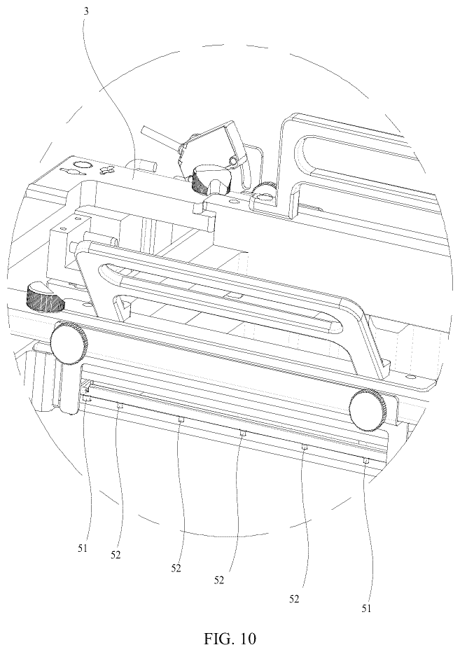

The bubble scraper 5 is mounted at the bottom of the extending area of the liquid bath 1 through one or more springs 52 and one or more guide shafts 51 as shown in FIGS. 9-10, and can float upwards or downwards slightly (for example: within a movement range of 2 mm) under the action of the spring and the guide shaft. When the release film horizontally moves leftwards or rightwards, the bubble scraper 5 horizontally moves leftwards or rightwards with respect to the release film to eliminate bubbles. The bubble scraper 5 may be a unidirectional bubble scraper or a bidirectional bubble scraper. Please refer to Chinese Patent Publication No. CN113942224A for the unidirectional bubble scraper, the contents of which is incorporated by reference.

According to the 3D printing device in this embodiment, the printing platform 2 and the release film 3 have been levelled and focused before printing. As shown in FIG. 3, the 3D printing device is used as follows:
1. Installation of the printing platform: horizontally moving the release film and the levelling hob assembly 4 to the left side of the liquid bath 1, and installing the printing platform 2;
2. Moving to a printing position: horizontally moving the release film and the levelling hob assembly 4 to the printing position on the right side of the liquid bath 1;
3. Ascending of the printing platform: controlling the printing platform 2 to ascend until the distance between the printing platform 2 and the lower surface of the release film is equal to one coating thickness, and waiting for levelling;
4. First step of rolling levelling: keeping the release film static with respect to the liquid bath 1, and moving the levelling hob assembly 4 leftwards unit it reaches the left side of the release film;
5. Second step of rolling levelling: keeping the release film static with respect to the liquid bath 1, moving the levelling hob assembly 4 rightwards unit it reaches the right side of the release film;
6. Repetition of rolling levelling: repeating Step 3 to Step 5 until a bulge of the release film is eliminated;
7. Exposure: focusing a pattern on the release film through projection of a UV surface by means of a UV lens 8, and performing exposure and curing to obtain a cured pattern, wherein the exposure may be single-projection exposure, projection exposure based on multiple photocuring printers, or multi-projection exposure driven by X and Y shafts;
8. Releasing: controlling the printing platform 2 to descend to separate the printed sample 7 obtained after curing from the release film;
9. First step of bubble removal: horizontally moving the release film and the levelling hob assembly 4 leftwards to the left side of the liquid bath 1, and triggering the unidirectional bubble scraper 5 to ascend to firmly contact with the lower surface of the release film;
10. Second step of bubble removal: horizontally moving the release film and the levelling hob assembly 4 rightwards to the printing position on the right side of the liquid bath 1, and in this process, controlling the bubble scraper 5 to operate to remove bubbles from the lower surface of the release film. When the release film and the levelling hob assembly 4 move to the right side of the liquid bath 1, triggering the unidirectional bubble scraper 5 to descend to be separated from the lower surface of the release film;
11. Printing layer by layer: repeating Step 3 to Step 10 until the sample is completely printed; and
12. Disassembly of the printing platform: horizontally moving the release film and the levelling hob assembly 4 to the left side of the liquid bath 1, and disassembling the printing platform 2 with the printed sample 7 from the liquid bath 1.

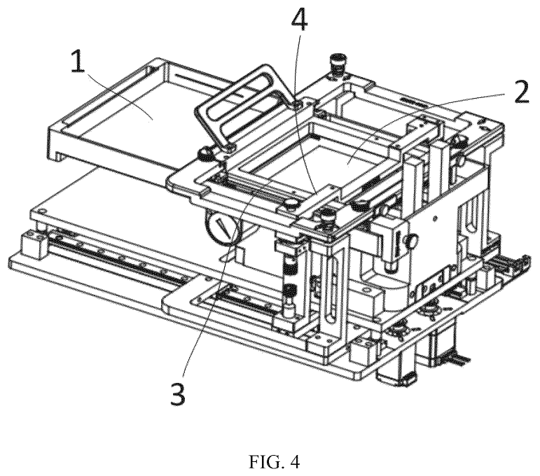

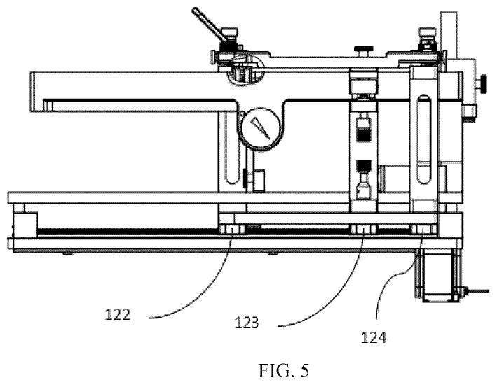

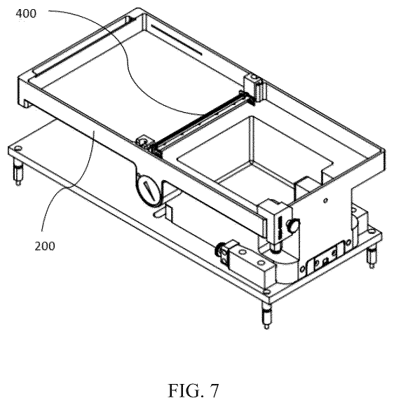

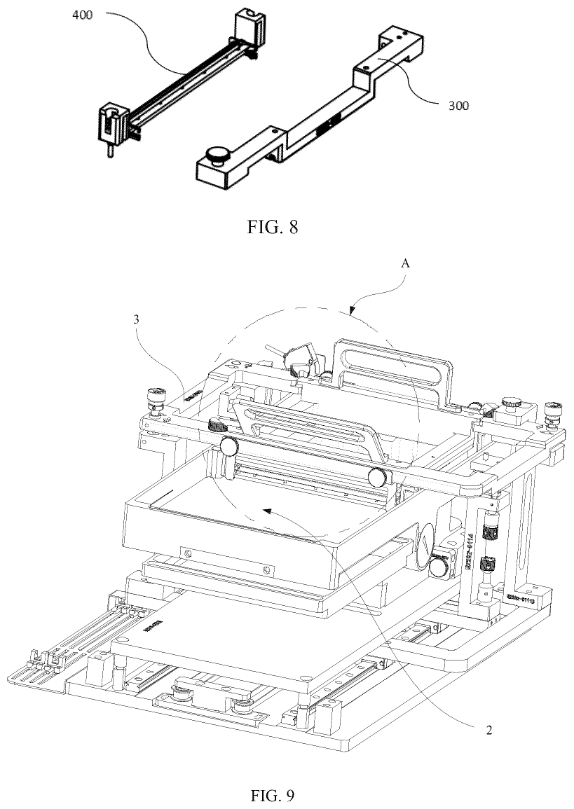

Preferably, as shown in FIG. 4, FIG. 5 and FIG. 7, according to the 3D printing device in this embodiment, a liquid bath main part 200 of the liquid bath 1 is hollow to contain liquid resin; as shown in FIG. 7, the main area on the right side of the liquid bath 1 is deep, the extending area on the left side of the liquid bath 1 is shallow, and a bubble scraper main part 400 is fixed at the bottom of the edge of the side, close to the main area, of the extending area.

Preferably, as shown in FIG. 4, FIG. 5 and FIG. 6, the release film assembly 3 comprises:

A mounting base plate 101;

Linear rails 102 and 103 extending in a first direction (the moving direction of the printing platform 2 between the main area and the extending area of the liquid bath 1) and fixed on the mounting base plate 101; and

A release film support unit mounted on the linear rails 102 and 103, driven by the release film driving unit to move in the first direction, and comprising a release film tensioning fixture 500, wherein the release film is mounted on the release film tensioning fixture 500.

Preferably, as shown in FIG. 5 and FIG. 6, the release film support unit comprises:

A transmission frame 109 connected to the linear rails 102 and 103 through first sliders 122 and 124;

Release film levelling pillars 110, 111 and 112 fixed on the transmission frame 109; and

A levelling frame 113 connected with the release film levelling pillars 110, 111 and 112 through release film levelling knobs 120 and 121, wherein the release film tensioning fixture 500 is mounted on the levelling frame 113.

By adopting this structure, the release film support unit can move in the first direction, and the levelness of the levelling frame 113 can be adjusted through the release film levelling knobs 120 and 121. Specifically, as shown in FIG. 6, the transmission frame 109 and the levelling frame 113 are rectangular, and the release film levelling pillars 110, 111 and 112 are mounted at three corners of the transmission frame 109 and the levelling frame 113. The release film tensioning fixture 500 can be levelled by levelling the levelling frame 113, thus ensuring that the release film is parallel with a projection focal plane. Upper ends of the three release film levelling pillars are connected with the levelling frame 113 through tension springs (not shown), levelling knobs and steel balls (not shown), such that the levelling frame 113 can be levelled through the levelling knobs. The number of the levelling knobs is two.

Preferably, as shown in FIG. 6, the release film driving unit comprises:

A first stepping motor 105 fixed at the bottom of the mounting base plate 101; and

A first synchronous belt 107 connected with the first stepping motor 105 and the transmission frame 109 to drive the transmission frame 109. Optionally, the release film driving unit may be any linear driving unit such as an assembly of a stepping motor, a linear guide rail and a synchronous belt, an assembly of a servo motor, a linear rail and a lead screw, or other assemblies capable of moving linearly.

Preferably, according to the 3D printing device easy to operate in this embodiment, as shown in FIG. 6, the hob driving unit comprises:

A second stepping motor 104 fixed at the bottom of the mounting base plate 101; and

A second synchronous belt 106 connected with the second stepping motor 104 and the hob support unit to drive the hob support unit, wherein the hob support unit is movably mounted on the linear rails 102 and 103. Further, the second synchronous belt 106 and the first synchronous belt 107 are arranged in parallel and aligned, and share one mounting frame.

Preferably, according to the 3D printing device easy to operate in this embodiment, as shown in FIG. 6, the hob support unit comprises:

A transmission link 115 connected with the linear rails 102 and 103 through second sliders 123 (shown in FIG. 5);

A rear hob levelling pillar 116 and a front hob levelling pillar 117 which are mounted on two sides of the transmission link 115 respectively, wherein a joint of the rear hob levelling pillar 116 and the transmission link 117 and a joint of the front hob levelling pillar 117 and the transmission link 115 are adjustable through a rear hob levelling knob 118 and a front hob levelling knob 119 respectively;

The top of the rear hob levelling pillar 116 and the top of the front hob levelling pillar 117 are connected with the levelling hob 300.

Optionally, as shown in FIG. 6, stop blocks 108 are disposed on the mounting base plate 101 and located at four corners of the mounting base plate 101 to prevent the transmission frame 109 from moving out of limit. A position sensor 114 is disposed on the mounting base plate 101, located on the edge of one side of the mounting base plate 101, and used for sensing the position of the transmission frame 109, and the horizontal moving position of the release film tensioning fixture 500 is limited by the position sensor 114.

The above ideal embodiments of the application are enlightenments, and with reference to the above description, relevant personnel can make various modifications and amendments without deviating from the scope of the technical concept of the application. The technical scope of the application is not limited to the above description in the specification, and should be defined according to the scope of the claims.

What is claimed is:

1. A 3D printing device, comprising:
a liquid bath (1) configured to contain liquid resin (6) used for printing, the liquid bath comprising a main area and an extending area disposed on a side of a top of the main area;
a printing platform (2) configured to carry a printed sample (7) and inserted into the main area of the liquid bath (1);
a release film assembly (3) comprising a release film and a release film driving unit used for driving the release film to move horizontally between the main area and the extending area;
a levelling hob assembly (4) comprising a levelling hob (300), and a hob driving unit configured for driving the levelling hob (300) to move horizontally between the main area and the extending area, a bottom of the levelling main part (300) being flush with an upper surface of the release film; and
a bubble scraper (5) disposed in the extending area, fixed on a bottom of the extending area of the liquid bath (1), and located at a side, close to the main area, of the extending area, a top of the bubble scraper (5) being flush with a bottom of the release film.

2. The 3D printing device according to claim 1, wherein the bubble scraper (5) is mounted on the bottom of the extending area of the liquid bath (1) through a spring (52) and a guide shaft (51).

3. The 3D printing device according to claim 1, wherein the release film assembly (3) comprises:
a mounting base plate (101);
linear rails (102, 103) fixed on the mounting base plate (101) and extending in a first direction, wherein the first direction is a moving direction of the printing platform (2) between the main area and the extending area of the liquid bath (1); and
a release film support unit mounted on the linear rails (102, 103), driven by the release film driving unit to move in the first direction, the release film support unit comprising a release film tensioning fixture (500), wherein the release film is mounted on the release film tensioning fixture (500).

4. The 3D printing device according to claim 3, wherein the release film support unit comprises:
a transmission frame (109) connected to the linear rails (102 and 103) through first sliders (122, 124);
release film levelling pillars (110, 111, 112) fixed on the transmission frame (109); and
a levelling frame (113) connected with the release film levelling pillars (110, 111, 112) through release film levelling knobs (120, 121), wherein the release film tensioning fixture (500) is mounted on the levelling frame (113).

5. The 3D printing device according to claim 4, wherein the release film driving unit comprises:
a first stepping motor (105) fixed at a bottom of the mounting base plate (101); and
a first synchronous belt (107) connected with the first stepping motor (105) and the transmission frame (109) to drive the transmission frame (109).

6. The 3D printing device according to claim 3, wherein stop blocks (108) are disposed on the mounting base plate (101) and located at four corners of the mounting base plate (101) to prevent the transmission frame (109) from moving out of limit.

7. The 3D printing device according to claim 4, wherein a position sensor (114) is disposed on the mounting base plate (101), located on an edge of a side of the mounting base plate (101), and used for sensing a position of the transmission frame (109), and a horizontal moving position of the release film tensioning fixture (500) is limited by the position sensor (114).

8. The 3D printing device according to claim 5, wherein the hob driving unit comprises:
a second stepping motor (104) fixed at the bottom of the mounting base plate (101); and
a second synchronous belt (106) connected with the second stepping motor (104) and a hob support unit to drive the hob support unit, wherein the hob support unit is movably mounted on the linear rails (102, 103).

9. The 3D printing device according to claim 8, wherein the hob support unit comprises:
a transmission link (115) connected with the linear rails (102, 103) through second sliders (123); and
a rear hob levelling pillar (116) and a front hob levelling pillar (117) which are mounted on two sides of the transmission link (115) respectively, wherein a joint of the rear hob levelling pillar (116) and the transmission link (117) and a joint of the front hob levelling pillar (117) and the transmission link (115) are adjustable through a rear hob levelling knob (118) and a front hob levelling knob (119) respectively;
wherein a top of the rear hob levelling pillar (116) and a top of the front hob levelling pillar (117) are connected with the levelling hob (300).

10. A 3D printing method using a release film to push liquid horizontally to realize coating, wherein the 3D printing device according to claim 1 is used and the 3D printing method comprises:
S1, moving the release film and the levelling hob assembly to the extending area, and installing the printing platform (2) in the main area of the liquid bath (1);
S2, controlling the release film to move to the main area, controlling the printing platform (2) to move to a printing position to ensure that the printing platform (2) is spaced from a lower surface of the release film by a coating thickness, and waiting for levelling;
S3, keeping the release film static, and moving the levelling hob assembly towards the main area of the liquid bath (1) unit it reaches an edge of one side of the release film;
S4, keeping the release film static, and moving the levelling hob assembly to an edge of an opposite side of the release film;
S5, repeating S3-S4 until a bulge of the release film is eliminated;
S6, focusing a pattern on the release film through a UV lens (8), and performing exposure and curing to obtain a cured pattern;
S7, controlling the printing platform (2) to descend to separate the printed sample (7) obtained after curing from the release film;
S8, controlling the release film and the levelling hob assembly to horizontally move to the extending area of the liquid bath (1), and then controlling the bubble scraper (5) to ascend to firmly contact the lower surface of the release film;
S9, controlling the release film and the levelling hob assembly to horizontally move to the main area of the liquid bath (1), removing bubbles accumulated at the lower surface of the release film by means of the bubble scraper (5), and then controlling the bubble scraper (5) to descend;
S10, repeating S2-S9 until the sample is completely printed; and
S11, controlling the release film and the levelling hob assembly to horizontally move to the extending area of the liquid bath (1), and disassembling the printing platform (2) with the printed sample (7) from the liquid bath.
